(19) United States
(12) Patent Application Publication
(10) Pub. No.: US 2015/0281914 A1
(43) Pub. Date: Oct. 1, 2015

(54) METHOD AND APPARATUS FOR ENABLING CALL SHARING BETWEEN USER DEVICES

(71) Applicant: Samsung Electronics Co., Ltd., Gyeonggi-do (KR)

(72) Inventors: Ganesh Babu Babu KAMMA, Bangalore (IN); Ajay Kumar Kabadi, Bangalore (IN); Jai-Dong Kim, Gyeonggi-do (KR); Hyeun Mok Jung, Gyeonggi-do (KR)

(73) Assignee: Samsung Electronics Co., Ltd.

(21) Appl. No.: 14/676,096

(22) Filed: Apr. 1, 2015

Related U.S. Application Data
(60) Provisional application No. 61/973,511, filed on Apr. 1, 2014.

(30) Foreign Application Priority Data
Feb. 11, 2015 (KR) 10-2015-0020928

(51) Int. Cl. H04W 4/06; H04M 3/436; H04M 1/725; H04W 4/16; H04M 3/56

(52) U.S. Cl. CPC H04W 4/06; H04W 4/16; H04M 3/56; H04M 1/72525; H04M 3/436

(57) ABSTRACT

A method and apparatus for enabling call sharing between devices are provided. The method includes installing a call sharing application in a user device and a first mobile device; establishing, by the user device, a connection with the first mobile device through the call sharing application for data transfer; receiving, by the first mobile device, a call request from the user device for establishing a voice call with a second mobile device; and performing, by the call sharing application in the first mobile device, at least one action in response to the call request from the user device.

### PRIORITY

This application claims priority under 35 U.S.C. §119(e) to U.S. Provisional Application No. 61/973,511, which was filed in the United State Patent and Trademark Office on Apr. 1, 2014, and under 35 U.S.C. §119(a) to Korean Patent Application serial No. 10-2015-0020928, which was filed in the Korean Intellectual Property Office on Feb. 11, 2015, the contents of which are incorporated herein by reference.

### BACKGROUND

1. Field of the Disclosure

The present disclosure generally relates to communication, and more particularly, to a method and apparatus for enabling call sharing between a user device and a plurality of external devices via a modem device.

2. Description of the Related Art

A modem, which is an acronym derived from a modulator-demodulator, is used to convert signals output from one type of equipment into a form suitable for input to another type. The modem is composed of a modulator for superimposing a data signal on a carrier wave according to a predetermined method, and a demodulator for receiving a modulated carrier wave and recreating the originally transmitted signal by removing the carrier wave.

The current communication methodologies allow a user to make a voice call by accessing the user's account related to his mobile phone, or any other communication device, during critical conditions such as low battery power and the like. For example, when a user A and a user B are in the same location, and the user B wishes to make a voice call to a user C, the user B may not have sufficient balance or credit in his account to initiate the call with the user C. As another example, when the user B's device is a non-modem device such as a tablet, and the user B wants to establish a voice call with user A by using the user B's device, it may not be possible because the user B's device is a non-modem device that cannot initiate the voice call.

The existing methodologies permit users to make voice calls by accessing their own account from their mobile phone/device, but there is not a process or system that allows the user to access the account of another user to make a voice call. Further, there is not a method or system that allows the user of a non-modem device to initiate a voice call over a modem device. Further, there is not a method and system that allows the user to initiate a group call with other users in the same location.

Thus, there is a need of an effective method and system for enabling voice call sharing that can overcome the above-described disadvantages.

### SUMMARY

The present disclosure has been made to solve the above-mentioned problem and/or disadvantages and to provide at least advantages described below. Accordingly, an aspect of the present disclosure is to provide a method and apparatus for enabling call sharing between a non-modem device and one or more modem devices.

In accordance with an aspect of the present disclosure, a method of enabling call sharing between devices is provided. The method includes installing a call sharing application in a user device and a first mobile device; establishing, by the user device, a connection with the first mobile device through the call sharing application for data transfer; receiving, by the first mobile device, a call request from the user device for establishing a voice call with at least one second mobile device; and performing, by the call sharing application in the first mobile device, at least one action in response to the call request from the user device.

In accordance with another aspect of the present disclosure, an apparatus for enabling call sharing between a plurality of user devices is provided. The apparatus includes a call sharing application module, installed in a user device and a first mobile device, configured to establish a connection between the user device and the first mobile device for data transfer, transfer a call request from the user device to the first mobile device, and perform at least one action in the first mobile device in response to the call request from the user device for establishing a voice call with at least one second mobile device.

### BRIEF DESCRIPTION OF THE DRAWINGS

The above and other aspects, features, and advantages of the present disclosure will be more apparent from the following description of the embodiment, taken in conjunction with the accompanying drawings, in which:

FIG. 1 is a diagram illustrating a method of enabling voice call sharing between user devices, according to an embodiment of the present disclosure;

FIG. 2 is a signal flow diagram illustrating a process of initiating a voice call between a non-modem device and a modem device, according to an embodiment of the present disclosure; and

FIG. 3 is a flowchart illustrating a method for voice call sharing, according to an embodiment of the present disclosure.

### DETAILED DESCRIPTION

The present disclosure provides a method and system enabling call sharing between a user device and a plurality of external devices via a modem device. In the following detailed description of the embodiments of the present disclosure, reference is made to the accompanying drawings that form a part hereof, and in which specific embodiments, in which the disclosure may be practiced, are shown by way of illustration. These embodiments are described in sufficient detail to enable those skilled in the art to practice the present disclosure, and it is to be understood that other embodiments may be utilized and that changes may be made without departing from the scope of the present disclosure. The following detailed description is, therefore, not to be taken in a limiting sense, and the scope of the present disclosure is defined by the appended claims and their equivalents.

The specification may refer to “an”, “one” or “some” embodiment(s) in several locations. This does not necessarily imply that each such reference is related to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “includes”, “comprises”, “including”, and/or “comprising”, when used in this specification, specify the presence of stated features, integers, steps, operations, elements, components, and/or groups, but do not preclude the presence or addition of one or more other features integers, steps, operations, elements, components, and/or groups thereof. As used herein, the term “and/or” includes any and all combinations and arrangements of one or more of the associated listed items.

Unless otherwise defined, all terms (including technical and scientific terms) used herein have the same meaning as commonly understood by one of ordinary skill in the art to which this disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

With an objective of allowing a user equipment (UE) or a mobile device to initiate a circuit switched (CS) or packet switched (PS) voice call with another mobile device through a user's account of another mobile device, the present disclosure describes a call sharing application based solution for voice call sharing. The call sharing application installed in the devices allows any user of a non-modem device to initiate a voice call using a user's account associated with a modem device.

The various embodiments herein disclose a method for enabling circuit switched (CS) or packet switched (PS) voice call sharing between user devices. Here, the call request is raised by a user device, which is a non-modem device. The non-modem device is in communication with a user mobile device over a wireless communication medium. Here, the user device and the user mobile device have installed thereon a call sharing application. The call sharing application running on the user device allows a first user device to initiate a call with a second user device (which is again a modem device) via a mobile device of the first user, using a mobile account of the first user.

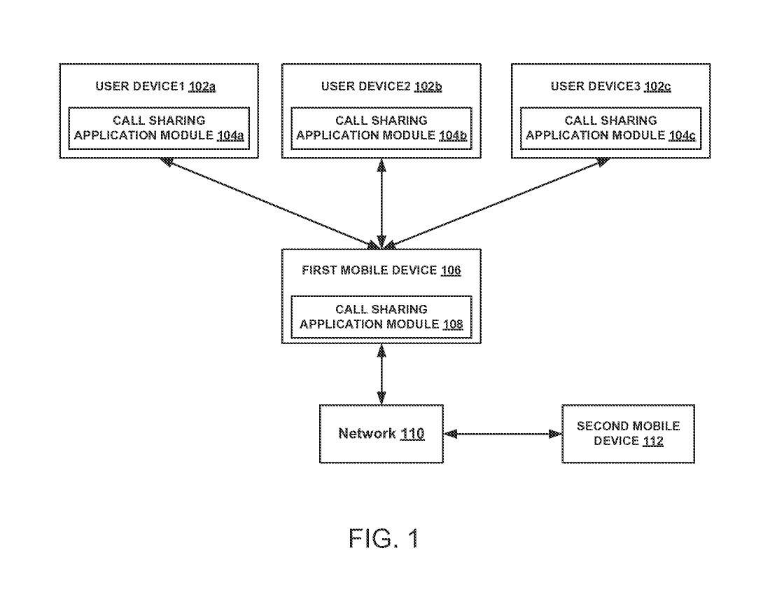

FIG. 1 is a diagram illustrating a method of enabling voice call sharing between user devices, according to an embodiment of the present disclosure. A plurality of user devices, user device 1 102a, user device 2 102b, user device 3 102c, . . . user device N in communication with a first mobile device 106. Each of the plurality of user devices 102a, 102b, and 102c comprises a call sharing application module 104a, 104b, and 104c, respectively, and the first mobile device 106 comprises the call sharing application module 108 installed therein.

The user device 1 102a, user device 2 102b, user device 3 102c, and the first mobile device 106 may be connected with any wireless connection technology for communication. The user device 1 102a, user device 2 102b, and user device 3 102c may be any embedded device, such as a mobile device, tablet, Personal Digital Assistant (PDA), TV, refrigerator, and the like, but is not limited thereto. The first mobile user 106 may be a mobile device that comprises a subscriber identification module (SIM) card such that the first mobile user 106 can have identification and can make a call to any other mobile device. The second mobile device 112 may be any mobile device that comprises SIM card for identification and can receive an incoming call from other devices.

The user device 1 102a, user device 2 102b, and user device 3 102c initiate a voice call with a second mobile device 112 using an account of the first mobile device 106. Here, the user device 1 102a, user device 2 102b, and user device 3 102c use call sharing application module 104a, 104b, and 104c, respectively, to communicate with the call sharing application module 108 in the first mobile device 106.

In an embodiment of the present disclosure, the wireless connection technology for connecting the first mobile device 106 and any of user device 1 102a, user device 2 102b, and user device 3 102c includes Wi-Fi, Bluetooth, near field communication (NFC), Hub, router, infrared, and the like, but is not limited thereto. The first mobile device 106 and any of user device 1 102a, user device 2 102b, and user device 3 102c are present within close proximity or at different locations, and the first mobile device 106 allows any of user device 1 102a, user device 2 102b, and user device 3 102c to make a voice call to the second mobile device 112. The network 110 is present to receive and transmit voice data to the devices.

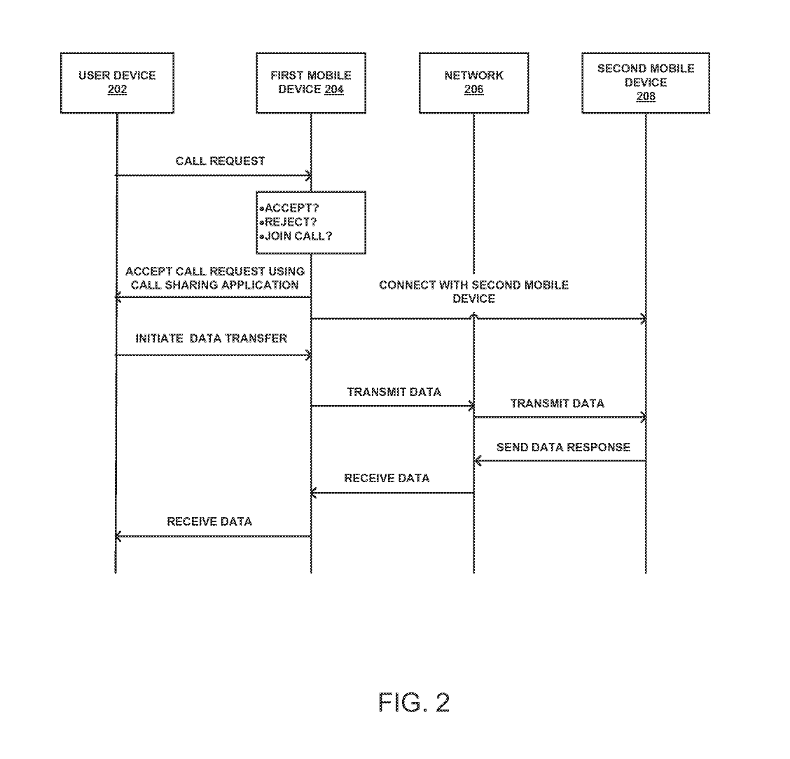

FIG. 2 is a signal flow diagram illustrating a process of initiating a voice call between a non-modem device and a modem device, according to an embodiment of the present disclosure. According to the embodiment of the present disclosure, the user device 202 and the first mobile device 204 are present in close proximity to each other, and are installed with a call sharing application module for communicating with each other. The user device 202 initiates a voice call request through the call sharing application module to the first mobile device. The call request transmitted from the user device 202 to the first mobile device 204 does not require any identification, as the devices are authenticated through the call sharing application module. Upon receiving the request, the call sharing application in the first mobile device 204 checks for the details in the call request, selects one of the options of accepting the call, rejecting the call, and joining the conference call, and intimates the same to the first mobile device 204. Here, “accepting the call” means the user device 202 is allowed to make a call to the second mobile device 208 using the account of the first mobile device 204, “rejecting the call” means that the user device 202 is not allowed to make a call to the second mobile device 208 using the account of the first mobile device 204, and “joining the conference” call means the user device 202 can make a call to the second mobile device 208 with the first mobile device 204 being connected.

If the option of accepting the call is selected, the first mobile device 204 accepts the call request and notifies the user device 202 with a message that the first mobile device 204 has accepted the call request to make a call to the second mobile device 208. The first mobile device 204 is connected to a network 206 for communicating with the second mobile device 208. Upon receiving a message as confirmation from the first mobile device 204, the user device 202 starts sending voice data packets to first mobile device 204 via the call sharing application module communicated over wireless communication. As the communication is established between the first mobile device 204 and the second mobile device 208 via the network 206, the first mobile device 204 transmits and receives the voice packets received from the user device 202 to the second mobile device 208 via the network 206 on behalf of the user device 202, thereby establishing a voice call between the user device 202 and the second mobile device 208 using the account of the first mobile device 204.

If the option of rejecting the call is selected, the user device 202 is not allowed to make a call to the second mobile device 208 using the account of the first mobile device 204.

If the option of joining a conference call is selected, steps similar to those of the option of accepting the call will be applied, with a further step of allowing the first mobile device to join the conference call with user device and the second mobile device.

In an embodiment of the present disclosure, the user device comprises a modem device, and the modem device makes a voice call. In this case, the user device uses the account of the mobile device to make a voice call with the second mobile device due to reasons, such as low credit for initiating a voice call, poor network connection (e.g., narrow bandwidth) to establish a voice call, and the like, but are not limited thereto. In another embodiment of the present disclosure, the user device is a non-modem device, which requires support of the first mobile device that is a modem device, to make a voice call with the second mobile device.

In an embodiment of the present disclosure, the user device makes the voice call to the second mobile device using the account of the first mobile device for initiating a conference call. In another embodiment of the present disclosure, the user device invites another device, for example, a third mobile device, to join the conference call. In another embodiment of the present disclosure, the user device invites one or more devices of one or more users to join the conference call. In yet another embodiment of the present disclosure, a non-modem user device makes a voice call with a second mobile device that is a non-modem device using the account of the first mobile device that is a modem device, and the non-modem second mobile device receives the voice call from an account of another modem mobile device (e.g., a fourth mobile device).

In an embodiment of the present disclosure, a first user device is in communication with a second user device. The first user device herein is a modem device such as a mobile device, and the second user device herein is non-modem device such as a tablet device, a refrigerator, or any automated device. The first user device (e.g., mobile device) and the second user device (e.g., tablet) are at different locations and are connected via any of Wi-Fi, Bluetooth, and NFC. Here, both the first user device and the second user device have the call sharing application installed therein. Here, it is assumed that the second user device wants to make a call to a third user device during an emergency condition. The second user device activates the installed call sharing application, calls the first user device (e.g., mobile device) via the call sharing application, and requests the first user device (e.g., mobile device) to initiate a voice call with the third user device using the account of the first user device (e.g., mobile device). The first user device (e.g., mobile device) receives the request, accepts the request from the second user device (e.g., tablet), and initiates the call with the third user device via the mobile network. Upon the first user device (e.g., mobile device) accepts the request, the second user device (e.g., tablet) sends the voice data packets, which is the data to be sent to the third user device and is part of a voice call, to the first user device (e.g., mobile device).

In another embodiment of the present disclosure, the first user device is a mobile device, the second user device is a tablet, and user device is a smart TV. The second user device (i.e., tablet) and the user device (i.e., smart TV) are non-modem devices and the first user device (i.e., mobile device) is a modem device. Here, it is assumed that the second user device (i.e., tablet) wants to make a voice call to the first user device (i.e., mobile device) with the user device (i.e., smart TV) joining the conversation. According to the method of the present disclosure, the second user device (i.e., tablet) uses the application installed, calls the first user device (i.e., mobile device) via the application, and requests the first user device (i.e., mobile device) to initiate the voice call using the account of the first user device (i.e., mobile device). The first user device (i.e., mobile device) receives the request, accepts the request from the second user device (i.e., tablet), initiates the call, and invites the user device (i.e., smart TV) to join the call. Thus, the first user device (i.e., mobile device), the second user device (i.e., tablet), and the user device (i.e., smart TV) can have a conference call using the first user device (i.e., mobile device).

In yet another embodiment of the present disclosure, in a home environment, a father uses a first user device, and the son uses a second user device. The first user device associated with the father has credit to make a voice call, whereas the second user device associated with the son does not have sufficient credit to initiate a voice call. If the son wants to make a call to his friend, the son connects his user device (i.e., the second user device) with the user device of his father (i.e., the first user device) using the application, and requests to make the call to his friend. Once the father accepts the son's request, the son can make a voice call to his friend using his father's user device, and the father's user device initiates a voice call to the son's friend.

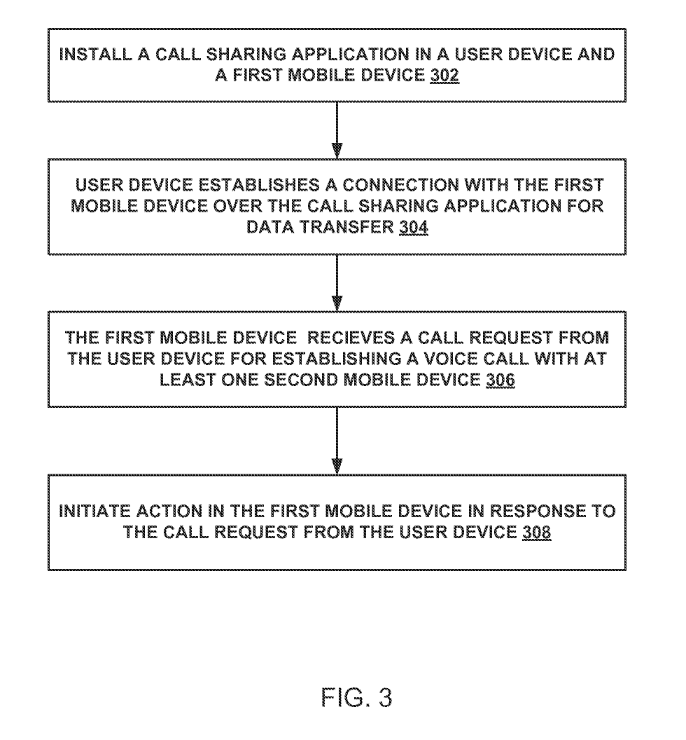

FIG. 3 is a flowchart illustrating a method for voice call sharing, according to an embodiment of the present disclosure.

At step 302, a call sharing application is installed in a user device and a first mobile device. In an embodiment of the present disclosure, the user device is a device with or without a modem, such as a mobile phone, a PDA, a tablet, a smart TV, a refrigerator, and the like, but is not limited thereto. In an embodiment of the present disclosure, the first mobile device is a mobile device that includes a SIM card, and the account of the first mobile device can be used for making the voice call.

At step 304, a connection can be established by the user device with the first mobile device through the call sharing application for data transfer. The user device establishes the connection with the first mobile device to make the voice call from the account of the first mobile device. In an embodiment of the present disclosure, the user device communicates with the first mobile device using wireless communication, which comprises Wi-Fi, Bluetooth, NFC, infrared, and the like, but is not limited thereto. The call sharing application installed on the user device communicates with the call sharing application installed on the first mobile device using the established connection.

At step 306, the first mobile device receives a call request from the user device for establishing a voice call with at least one second mobile device. The user device, using the call sharing application, requests the first mobile device to make a voice call to the second mobile device. The first mobile device receives the request from the user device for making a voice call to the second mobile device.

At step 308, the call sharing application in the first mobile device performs at least one action in response to the call request from the user device. The at least one action includes allowing the user device to establish a voice call with the at least one second mobile device using a caller account of the first mobile device, conferencing the user device with one or more second mobile devices, and rejecting the call request from the user device. If the first mobile device accepts to make the voice call, the user device can make the voice call to the second mobile device using the account of the first mobile device. The first mobile device is connected to a mobile base station for establishing a call. If the first mobile device accepts the request to make the conference call, the user device can make the voice call to one or more second mobile devices using the account of the first mobile device while having the first mobile device joining the conference call. If the first mobile device rejects the request to make the voice call, the user device cannot make the voice call to the second mobile device using the account of the first mobile device.

Although the present disclosure has been described with reference to specific embodiments, it will be evident that various modifications and changes may be made to these embodiments without departing from the spirit and scope of the present disclosure. Furthermore, the various devices, modules, and the like described herein may be enabled and operated using hardware circuitry, for example, complementary metal oxide semiconductor based logic circuitry, firmware, software and/or any combination of hardware, firmware, and/or software embodied in a machine readable medium. For example, the various electrical structures and methods may be embodied using transistors, logic gates, and electrical circuits, such as application specific integrated circuits.

Although the embodiments herein are described with various specific embodiments, it will be obvious for a person skilled in the art to practice the present disclosure with modifications. However, all such modifications are deemed to be within the scope of the claims. It is also to be understood that the following claims are intended to cover all of the generic and specific features of the embodiments described herein and all the statements of the scope of the present disclosure, which, as a matter of language, might be said to fall there between. It will be understood by those skilled in the art that various changes in form and details may be made therein without departing from the spirit and scope of the present disclosure as defined by the appended claims and their equivalents.

What is claimed is:

1. A method of enabling call sharing between devices, the method comprising:
installing a call sharing application in a user device and a first mobile device;
establishing, by the user device, a connection with the first mobile device through the call sharing application for data transfer;
receiving, by the first mobile device, a call request from the user device for establishing a voice call with at least one second mobile device; and
performing, by the call sharing application in the first mobile device, at least one action in response to the call request from the user device.

2. The method of claim 1, wherein performing the at least one action comprises:
allowing the user device to establish the voice call with the at least one second mobile device using a caller account of the first mobile device;
conferencing the user device with one or more second mobile devices; and
rejecting the call request from the user device.

3. The method of claim 1, wherein establishing the connection comprises establishing, by the call sharing application in the user device, the connection with the call sharing application in the first mobile device over at least one of Bluetooth, Near Field Communication, Wi-Fi, and Wi-Fi direct.

4. The method of claim 1, wherein the user device is a non-modem device comprising at least one of a tablet device, a smart television, and a smart refrigerator.

5. The method of claim 1, wherein the first mobile device is connected to a mobile base station for establishing a call.

6. An apparatus for enabling call sharing, the apparatus comprising:
a call sharing application module, installed in a user device and a first mobile device, configured to:
establish a connection between the user device and the first mobile device for data transfer;
transfer a call request from the user device to the first mobile device; and
perform at least one action in the first mobile device in response to the call request from the user device for establishing a voice call with at least one second mobile device.

7. The apparatus of claim 6, wherein the at least one action performed by the call sharing application in the first mobile device comprises:
allowing the user device to establish the voice call with the at least one second mobile device using a caller account of the first mobile device;
conferencing the user device with one or more second mobile devices; and
rejecting the call request from the user device.

8. The apparatus of claim 6, wherein the call sharing application in the user device is further configured to establish the connection with the call sharing application in the first mobile over at least one of Bluetooth, Near Field Communication, Wi-Fi, and Wi-Fi direct.

9. The apparatus of claim 6, wherein the user device is a non-modem device comprising at least one of a tablet device, a smart television, and a smart refrigerator.

10. The apparatus of claim 6, wherein the first mobile device is connected to a mobile base station for establishing a call.
